(19) United States
(12) Patent Application Publication
(10) Pub. No.: US 2004/0204134 A1
(43) Pub. Date: Oct. 14, 2004

(54) Web search results for a handheld wireless communication device

(76) Inventors: Samir Khalil Khazaka, San Diego, CA (US); Bradley C. Kirn, San Diego, CA (US)

Correspondence Address: Qualcomm Incorporated, Patents Department, 5775 Morehouse Drive, San Diego, CA, 92121-1714, US

(21) Appl. No.: 10/302,312

(22) Filed: Nov. 21, 2002

(51) Int. Cl. H04B 1/38; H04M 3/42

(52) U.S. Cl. 455/566; 455/414.1

(57) ABSTRACT

A method and apparatus collects a plurality of Web content containing a plurality of keywords from a plurality of Web sites, and classifies the collected Web content by screen size. In response to receipt of a keyword, the method and apparatus provide the Web content classified for the screen size and containing the keyword.

### BACKGROUND

1. Field

The present invention relates generally to wireless communications, and more specifically to providing Web search results to a handheld wireless communication device.

2. Background

The Word Wide Web is an Internet service that links documents locally and remotely. Documents are stored on the Internet in Web servers that store and disseminate Web pages. A user accesses the Web pages with software called a Web browser, the two most popular being Internet Explorer and Netscape Navigator.

A Web site is a location on the World Wide Web stored in a Web server. Each Web site typically contains a home page, which is the first document a user sees when they enter the Web site. The Web site might also contain additional documents and files. Each Web site is typically owned and managed by an individual, company, or organization.

A Web browser is a program running on a handheld wireless communication device, a laptop computer, or a desktop computer. The Web browser serves as the front end to the World Wide Web on the Internet. In order to view a Web site, an Uniform Resource Locator (URL) can be typed into the browser's ADDRESS field, and the home Web page of the corresponding Web site is downloaded to the PDA or computer. Browsers can have a bookmark feature that stores references to favorite Web sites. Instead of typing in the URL again to visit the Web site, the user can select one of the bookmarks.

An URL is an address that defines the route to a file on the Web or any other Internet facility. URLs can also be embedded within the Web pages themselves to provide the hypertext links to other Web pages.

The URL contains the protocol prefix, port number, domain name, subdirectory names and file name. To access a home page on a Web site, only the protocol and domain name are required. For example, “http” “www.qualcomm.com” retrieves the home page at Qualcomm, Inc.'s, Web site. The “http” is the Web protocol, and “www.qualcomm.com” is the domain name.

If the Web page is stored in another directory, or if a Web page other than the home page is required, slashes are used to separate the names. For example, http://www.qualcomm.com/index.html points to the index Web page.

Web pages are maintained at Web servers. A Web server is a computer that provides World Wide Web services on the Internet. The Web server can include the hardware, operating system, Web server software, protocols, and the Web pages. If the Web server is used internally and not by the public, it may be known as an “intranet server.”

When a user accesses a Web site, generally, the first link it to the Web site's home page, which is an hypertext markup language (HTML) document that serves as an index, or springboard, to the Web site's contents. On the Internet, “content” is any information that is available for retrieval by a user, including Web pages, images, music, audio, white papers, driver and software downloads as well as training, educational and reference materials.

The Web page can contain text, graphics, animations and videos as well as hypertext links (URLs). The links in the Web page let users jump from Web page to Web page whether the Web pages are stored on the same server or on other servers.

The fundamental Web format is a text document embedded with HTML tags that provide the formatting of the Web page as well as the hypertext links to other Web pages

Web pages are built with HTML tags (codes) embedded in the text. HTML defines the page layout, fonts and graphic elements as well as the hypertext links to other documents on the Web. Each link contains the URL, or address, of a Web page residing on the same server or any server worldwide

A search engine is a program that searches for Web pages on the World Wide Web based on specified keywords and returns search results. The search results are typically a list of the Web content containing the keywords. The list may include titles of the documents hypertext linked by the URL of the document.

The terms “search engine” and “Web search site” are typically used synonymously, although the former technically describes the software and methodology used, while the latter refers to the site itself.

There are various Web search sites that maintain databases about the contents of other Web sites. Some Web search sites index content by people who create a hierarchical directory by subject. Most other Web search sites are highly automated, sending spider programs out on the Web around the clock to collect the text of Web pages. Spiders follow all the links on a page and put all the text into one gigantic database, which is searched when the Web search site used. Sometimes, a Web search site will offer both search engine and directory capabilities. There are also Web search sites that search other sites. These meta-search engines bring results from multiple search engines at one time.

Handheld wireless communication devices, for example, a wireless personal digital assistant (PDA), a wireless handheld computer, and a wireless Web-enabled cell phone, have a small elongated rectangular display screen mounted on the front wall of the housing of the device. The viewing orientation on the display screen is typically in a vertically elongated orientation, also called a “portrait” orientation. In the portrait orientation, the image on the display screen is greater in dimension in the vertical direction than it is in the horizontal direction.

Handheld wireless communication devices can access Web sites designed for displaying Web pages on monitors of desktop computers or laptop computers. These Web sites are referred to as standard Web sites, and their Web pages are referred to as standard Web pages. Handheld wireless communication devices also can access Web sites designed for displaying Web pages on a display screen of a handheld wireless communication device. These Web sites are referred to as a wireless portal, and their Web pages are referred to as wireless Web pages. The Web pages are typically designed with more text and little graphic to facilitate a quick download over slow wireless links. As the speed of wireless links improve, for example, with certain versions of cdma2000 and third-generation systems, the content of wireless Web pages will increase. Nevertheless, the wireless Web pages will be designed for display on the display screen.

When a wireless portal is accessed, it would be better to display the wireless Web page on the portrait-oriented display screen because the wireless Web page is formatted for the size of the display screen. When a standard Web page is viewed on a portrait-oriented display screen, however, only a corner of the wireless Web page is shown. This is due to the difference in size between the screen display of the handheld device and the monitor of the desktop computer. The viewed corner is in a portrait orientation rather than the landscape orientation typical of monitors of desktop computers or laptop computers. The user might find it inconvenient to browse the standard Web page because of the scrolling, especially in the horizontal direction, to view the entire standard Web page.

A need exists for a method and apparatus that can automatically provide wireless Web pages to the wireless communication device, or identify the wireless Web pages when both wireless Web pages and standard Web pages are provided to the wireless communication device.

### BRIEF DESCRIPTION OF THE DRAWINGS

FIG. 1 illustrates a handheld wireless communication device with a display screen in portrait orientation;

FIG. 2 illustrates a system for providing Web search results to a handheld wireless communication device; and

FIG. 3 illustrates a method of providing Web search results to a handheld wireless communication device.

### DETAILED DESCRIPTION

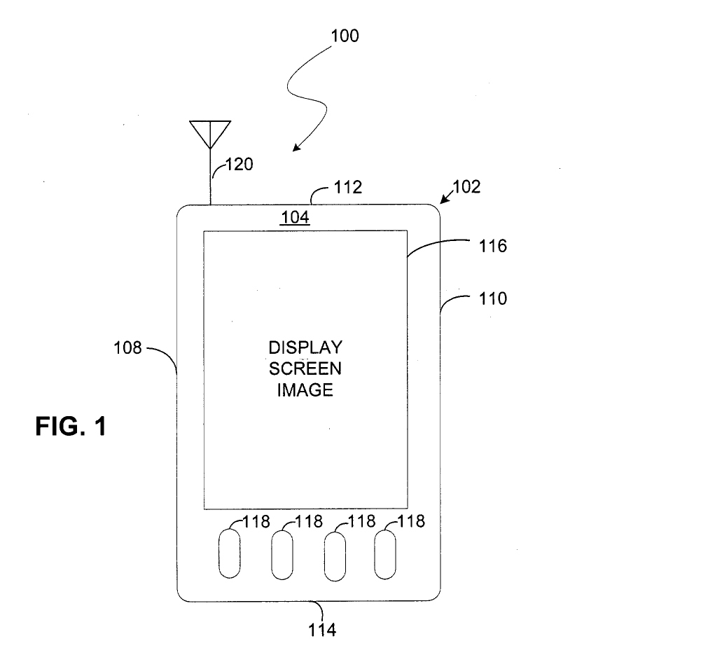

FIG. 1 illustrates a handheld wireless communication device with a display screen in portrait orientation.

The handheld wireless communication devices can be one of many conventionally known, for example, Palm VII (™) brand personal digital assistant (PDA) by Palm operating AvantGo portrait-only oriented browser, Pocket IE portrait- and landscape-oriented browser, or ThunderHawk landscape-only oriented browser, or a combination thereof. Other Internet-enabled wireless communication devices could also be used, for example, handheld computers and cellular telephones.

The handheld wireless communication device 100 can include an elongated rectangular housing 102 in which the electronic circuitry (not shown) of the device is operatively disposed. Housing 102 has a front wall 104, a left sidewall 108, a right sidewall 110, a top end wall 112, and a bottom end wall 114.

A display screen 116 is operatively mounted on the front wall 104 and, as viewed in FIG. 1, has a vertically elongated rectangular configuration. Also mounted on the front housing sidewall 104, directly beneath the bottom end of the display screen 116, are four horizontally spaced apart, vertically elongated user input buttons 118. An antenna 120 is mounted on the housing 102 to transmit and receive wireless signals between the wireless communication device and a Web search site that can provide Web content.

The handheld wireless communication device 100 can typically be operated in one of two different display screen orientations—a “portrait” orientation (FIG. 1) in which the length of the display screen 116 is vertically oriented, and a “landscape” orientation in which the length of the display screen is horizontally oriented and rotated ninety degrees in a counterclockwise direction from its FIG. 1 portrait orientation.

With the wireless communication device 100 in its FIG. 1 portrait orientation, when the user selects a particular Web page, the browser generates on the display screen 116 a display screen image that may comprise text or graphics or both. With the wireless communication device in its FIG. 1 portrait orientation, the display screen text and graphics can be presented to the user in what may be termed a normal “upright” orientation, that is, the displayed text or graphics reads from left to right across the screen.

Conventional hardware representatively utilized in the wireless communication device 100 can include a central processing unit (CPU) electrically connected to memory, video controller, and a wireless modem via a local bus; and a bus interface electrically connected to a system bus. The system bus can comprise address, data and control buses as are well known in the art, and provides communication between the CPU and input/output (I/O) devices such as personal computer memory card interface association (PCMCIA) cards, a fax modem, a hard disk, and other I/O devices. The antenna can be coupled to the wireless modem.

In operation, the CPU executes instructions stored in the memory, and communicates information to the video controller to display applicable programs and data on the display screen 116. The CPU has a plurality of I/O interrupt signal lines which are operatively connected to the control buttons 118 and touch-screen display screen 116 to allow the wireless communication device's user to input commands to the CPU. The signal lines can be used during execution of a display subroutine. These elements, their basic functionality, and their relationship to one another are known to one of ordinary skill in the art.

There are numerous conventional Web browsers for handheld wireless communication devices that are portrait oriented, for example, AvantGo (™) brand browser by AvantGo, Web Whacker (™) brand browser by Blue Squirrel, Pocket Browser (™) brand browser by Conduits Technologies, Pocket IE (™) brand browser by Microsoft, EudoraWeb (™) brand browser by Qualcomm, and Whack Force (™) brand browser by Ruksun Software Technologies.

A user of the wireless communication device 100 can enter the URL of a Web search site into the ADDRESS box of a Web browser operating on the wireless communication device. By the user pressing SEND, the wireless communication device can wirelessly access and receive a Web page on a remote server. (Block 203.) One of ordinary skill in the art will recognize other ways to access and receive a Web page, for example, click on a hyperlink embedded in a Web page displayed on the display screen, or running an application that automatically accesses a Web site.

The URL of a home Web page of a Web search site can be sent by the wireless communication device 100. The returned home Web page can include a SEARCH box for entering one or more keywords (referred herein as a “keyword”). A user can enter the keyword into the SEARCH box and press SEND. The wireless communication device can also be configured to send an indication of the display screen size, for example, an indication of the Web browser operating on the wireless communication device or the type of wireless communication device. For example, wireless communication devices running the Pocket IE Web browser can have a common screen size, and each different type of cell phone can have a corresponding screen size. The Kyocera QCP™ 6035 cell phone type can have a common screen size of 2 inches by 2 inches. Certain models of Palm™ handheld devices can also have certain sized display screens.

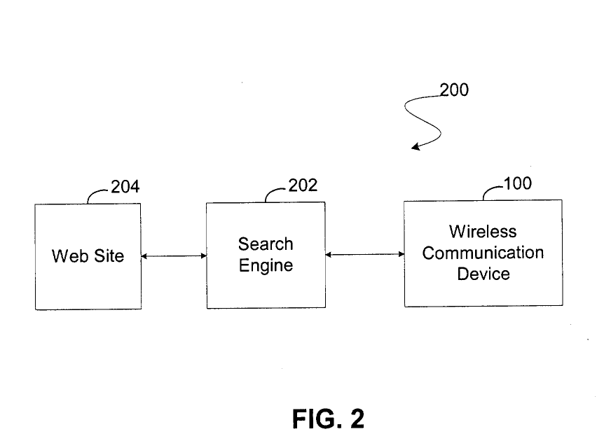

FIG. 2 illustrates a system 200 for providing Web search results to a handheld wireless communication device.

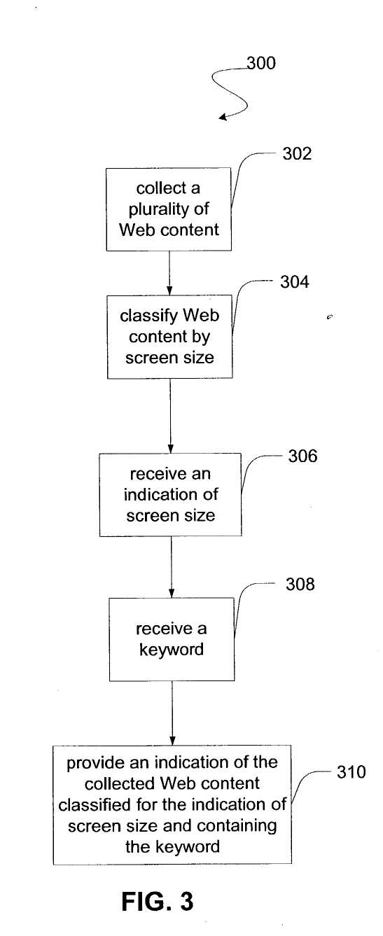

System 200 comprises the wireless communication device 100, a search engine 202 running on a Web search site, and a Web site comprising Web content. The Web site and Web content are of conventionally known types. The search engine can be of conventionally known types modified by the method and functionality as described with reference to FIG. 3.

FIG. 3 illustrates a method 300 of providing Web search results to the wireless communication device 100.

At block 302, the search engine 202 collects a plurality of Web content containing a plurality of keywords from a plurality of Web sites 204. At block 304, the search engine classifies the collected Web content by screen size. The search engine can classify by identifying HTML tags in the collected Web content that define the page layout, thus indicating that the collected Web content is formatted for a particular screen size. Also, the format of the collected Web content can be analyzed.

At block 306, the search engine 202 receives, from the wireless communication device 100, the indication of screen size. At block 308, the search engine receives, from the wireless communication device 100, the keyword.

At block 310, the search engine provides, to the wireless communication device, the search results, for example, an indication of the collected Web content classified for the received indication of screen size and containing the received keyword. The indication of the collected Web content can comprise a list of documents or media hypertext linked by the URL of the document.

The search engine can also provide, to the WCD, an indication of collected Web content not classified for the received indication of screen size and containing the received keyword. In this configuration, the search engine can highlight the indication of collected Web content classified for the received indication of screen size and containing the received keyword. The user can then have the choice of Web content for display.

For example, the user can choose the listed documents that are highlighted on the screen display, as opposed to the listed document that are not highlighted, if the user chooses only to view Web content formatted for the particular wireless communication device.

There are several ways to determine whether a collected Web page is a standard Web page or a wireless Web page that will be appreciated by one of ordinary skill in the art. For example, the Web page can be a Hypertext Markup Language (HTML) document that uses markup tags to mark the elements of a file. An element is a fundamental component of the structure of a text document, for example, heads, titles, headings, paragraphs, tables, text, and lists. Some elements can contain an attribute, which is additional information that is included in the tag. This and other additional information may be alignment, start of a new paragraph, font, maximum number of characters for a line, forced line break, character formatting, color, size of images being downloaded with text alignment of images, alternate text for images, and the like. From the elements, attributes, and other content of the HTML document, the search engine can classify the Web content for screen size. The classification may be grouped into ranges of screen sizes, or for particular types of wireless communication devices.

Further, a header could be placed in the Web page that identifies the screen size of the Web content.

One of ordinary skill in the art will appreciate that the above principles for determining image orientation can also be applied to other languages for producing Web page documents, for example, Extensible Markup Language (XML), Handheld Device Markup Language (HDML), and Wireless Markup Language (WML).

The above-described embodiment assumed that the vertical orientation of the display screen is the standard orientation of a wireless communication device and that the landscape orientation is the standard orientation for a Web page. One of ordinary skill in the art will appreciate that a horizontal orientation may be a standard orientation on certain wireless communication devices and that a vertical orientation may be a standard orientation for Web pages. One of ordinary skill in the art can easily apply the above principles to the latter situation.

In summary, the wireless communication device can display an accessed Web page in the appropriate orientation on the handheld wireless communication device without intervention by the user.

What is claimed is:

1. A method of providing search results to a wireless communication device (WCD), the method comprising:
collecting, by a search engine, a plurality of Web content containing a plurality of keywords from a plurality of Web sites;
classifying, by the search engine, the collected Web content by screen size;
receiving, by the search engine from the WCD, an indication of screen size;
receiving, by the search engine from the WCD, a keyword of the plurality of keywords to the search engine; and
providing, to the WCD by the search engine in response to the received indication of screen size and the received keyword, an indication of the collected Web content classified for the received indication of screen size and containing the received keyword.

2. The method of claim 1, wherein classifying the collected Web content by screen size comprises identifying tags in the collected Web content that indicate that the collected Web content is formatted for a particular screen size.

3. The method of claim 1, wherein classifying the collected Web content by screen size comprises analyzing the format of the collected Web content.

4. The method of claim 1 further comprising:
providing, to the WCD by the search engine in response to the received keyword, an indication of collected Web content not classified for the received indication of screen size and containing the received keyword; and
highlighting, by the search engine, the indication of collected Web content classified for the received indication of screen size and containing the received keyword.

5. The method of claim 1, wherein the indication of screen size comprises an indication of a Web browser operating on the WCD.

6. The method of claim 1, wherein the indication of screen size comprises an indication of the type of WCD.

7. A system for providing search results, the system comprising:
a wireless communication device (WCD) configured to provide an indication of screen size and a keyword of a plurality of keywords; and
a search engine configured to collect a plurality of Web content containing the plurality of keywords, to classify the collected Web content by screen size, to receive the indication of screen size, to receive the keyword, and to provide an indication of the collected Web content classified for the indication of screen size and containing the keyword to the WCD.

8. The apparatus of claim 7, wherein the search engine classifies the collected Web content by screen size by identifying tags in the collected Web content that indicate that the collected Web content is formatted for a particular screen size.

9. The apparatus of claim 7, wherein the search engine classifies the collected Web content by screen size by analyzing the format of the collected Web content.

10. The apparatus of claim 7, wherein:
the Web-based search engine is further configured to provide an indication of the collected Web content not classified for the indication of screen size and containing the keyword to the WCD, and to highlight the indication of collected Web content classified for the indication of screen size and containing the keyword; and
the WCD is further configured to display the highlighted indication of collected Web content classified for the indication of screen size and containing the keyword to the WCD.

11. The apparatus of claim 7, wherein the indication of screen size comprises an indication of a Web browser operating on the WCD.

12. The apparatus of claim 7, wherein the indication of screen size comprises an indication of the type of WCD.

13. An apparatus for providing search results to a wireless communication device (WCD) having a display screen, the apparatus comprising:
means for collecting a plurality of Web content containing a plurality of keywords from a plurality of Web sites;
means for classifying the collected Web content by screen size;
means for receiving an indication of screen size;
means for receiving a keyword of the plurality of keywords; and
means for providing, in response to the indication of screen size and the keyword, an indication of the collected Web content classified for the indication of screen size and containing the keyword.
